(19) United States
(12) Patent Application Publication
(10) Pub. No.: US 2008/0270566 A1
(43) Pub. Date: Oct. 30, 2008

(54) SYSTEM AND METHOD OF HOSTING OR PUBLISHING OF CONTENT

(76) Inventors: Gregory J. LIPINSKI, Loveland, CO (US); Philip M. Walker, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/740,822

(22) Filed: Apr. 26, 2007

(51) Int. Cl. G06F 15/167

(52) U.S. Cl. 709/216; 709/232

(57) ABSTRACT

System and method of hosting or publishing of content. At least some of the illustrative embodiments are methods comprising coupling a memory device to a computer system, displaying content of the memory device on the computer system, selecting by the user at least some of the content displayed, generating a web page utilizing the content selected by the user (the generating occurring autonomously of the user), and publishing the web page to a server (the publishing occurring autonomously of the user).

### BACKGROUND

Creating web pages (e.g., web pages viewable using a web browser) and changing content of web pages are tasks that utilize in-depth knowledge of hypertext markup language (HTML) and are very time-consuming. For these reasons, most home-based computer system users either do not utilize web pages as a mechanism to share photographs and other documents with family and friends, or if they do, the web page content is static and difficult to change. Moreover, even if a user has a fully developed web page, publishing the web page to a server is cumbersome, forces the home-based user to have space available on a remote server available, and usually requires incurring a monthly charge.

### BRIEF DESCRIPTION OF THE DRAWINGS

For a detailed description of exemplary embodiments, reference will now be made to the accompanying drawings in which:

FIG. 1 shows a system in accordance with at least some embodiments;

FIG. 2 shows in greater detail a home network server in accordance with at least some embodiments; and

FIG. 3 shows a method in accordance with at least some embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ”

Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to various embodiments. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

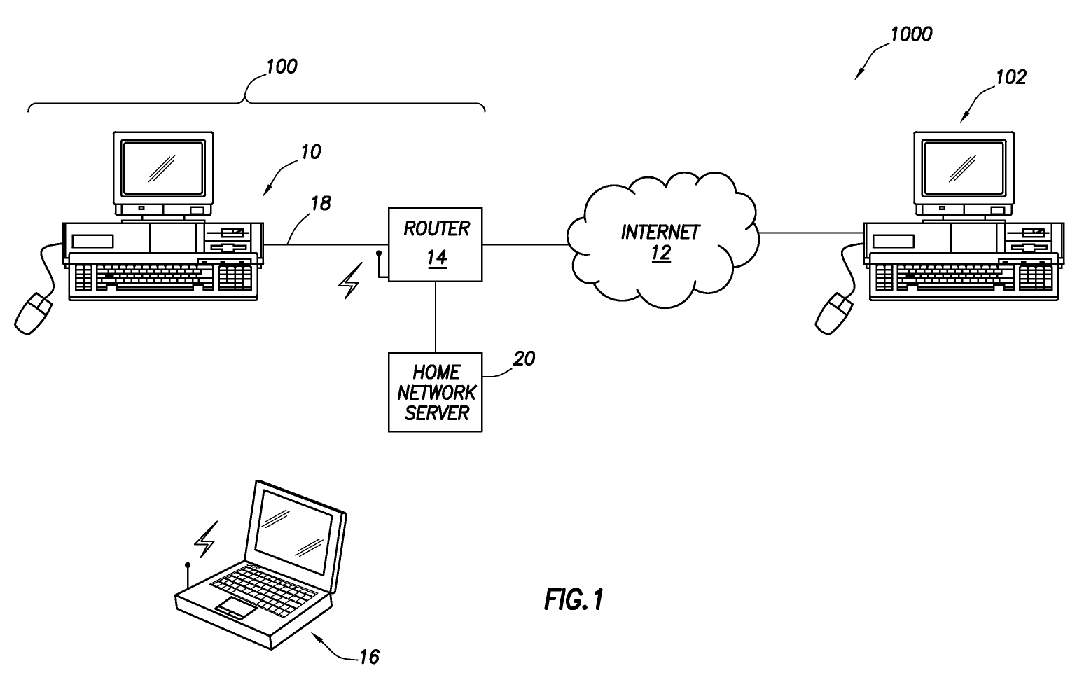

FIG. 1 illustrates a system 1000 in accordance with at least some embodiments. In particular, the system 1000 comprises a home network system 100 and communicatively coupled to a remotely located computer system 102 (i.e., computer system 102 physically located an appreciable distance (e.g., miles) from the home network system). The home network system 100 comprises an illustrative desktop computer system 10 coupled to the Internet 12 by way of a router 14. The home network system 100 also comprises a second computer system, in this case a portable computer system 16, coupled to the Internet 12 by way of the router 14. In the embodiments illustrated in FIG. 1, desktop computer system 10 couples to the router by way of a hardwired connection 18 (e.g., an Ethernet connection) and illustrative portable computer system 16 couples to the router 14 wirelessly (e.g., IEEE 802.11, Bluetooth). However, computer systems may couple to the router in a hardwired fashion and/or wirelessly without regard to their portability. Further, while the home network system 100 of FIG. 1 shows only one desktop computer system 10 and one portable computer system 16, any number of computer systems may be coupled to the router using any networking functionality.

The home network system 100 of FIG. 1 also comprises a home network server 20 coupled to the router 14. The home network server 20 is a storage device and/or server available to any computer system of the home network system 100 (e.g., desktop computer system 10 or portable notebook computer system 16), and in some cases the home network server 20 is also available to the remote computer system 102. The home network server 20 may be, for example, the central repository for data generated by computer systems of the home network system 100 and the server from which web pages are hosted. In the embodiments illustrated in FIG. 1, the storage implemented by home network server 20 is accessible to other computer systems by way of any suitable currently available networking communication protocol (e.g., Internet Protocol (IP), Transmission Control Protocol/Internet Protocol (TCP/IP), server message block (SMB)/common internet file system (CIFS)), or any after-developed networking protocol. Thus, the home network server 20 operates, at least in part, as a network attached storage (NAS) device.

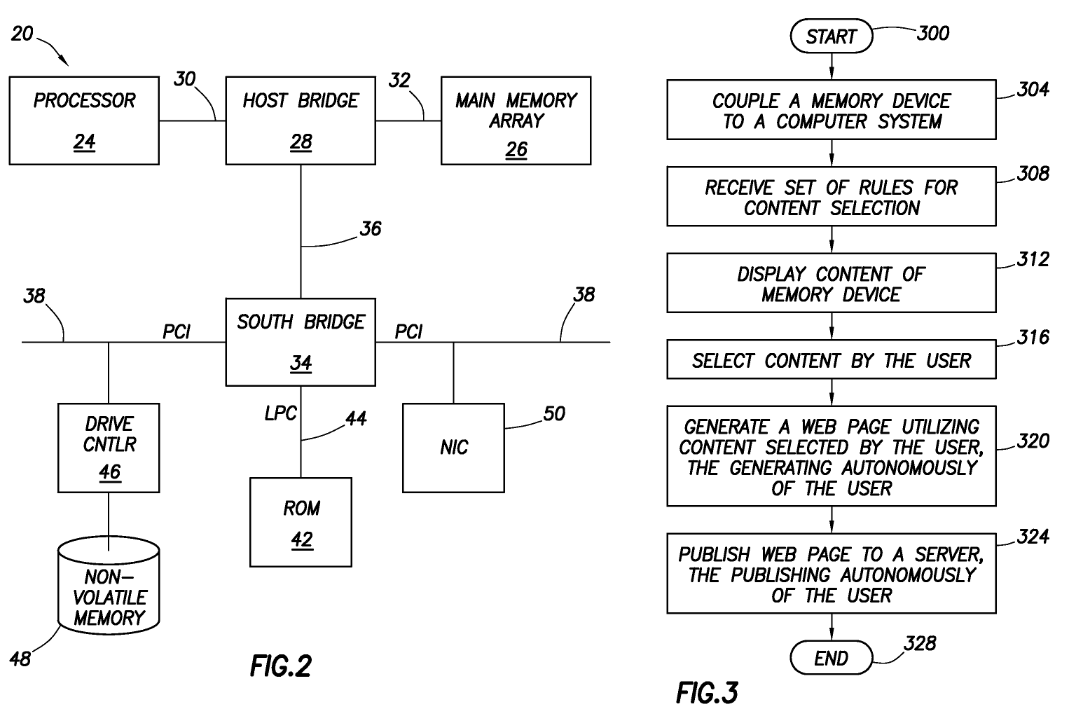

FIG. 2 illustrates in greater detail an embodiment of the home network server 20. In particular, home network sever 20 comprises a processor 24 coupled to a main memory array 26 and various other components through host bridge 28. The processor 24 couples to the host bridge 28 (sometimes referred to as a “north bridge” because of its location in computer system drawings) by way of a host bus 30, or the host bridge 28 may be integrated into the processor 24. The processor 24 may be one of many available processors, and thus the home network server 20 may implement other bus configurations or bus-bridges in addition to, or in place of, those shown in FIG. 2.

Main memory array 26 couples to the host bridge 28 through a memory bus 32. The host bridge 28 comprises a memory control unit that controls transactions to the main memory 26 by asserting control signals for memory accesses. The main memory array 26 functions as the working memory for the processor 24 and comprises a memory device or array of memory devices in which programs, instructions and data are stored. The main memory array 26 may comprise any suitable type of memory such as dynamic random access memory (DRAM) or any of the various types of DRAM devices such as synchronous DRAM (SDRAM), extended data output DRAM (EDODRAM), or Rambus DRAM (RDRAM).

Still referring to FIG. 2, the home network server 20 also comprises a second bridge 34 that bridges the primary expansion bus 36 to various secondary expansion buses, such as the peripheral component interconnect (PCI) bus 38 and the low pin count (LPC) bus 44. The second bridge 34 may be referred to as the “south bridge” because of its location in computer system drawings. Read only memory (ROM) 42 couples to the south bridge 34, such as by the LPC bus 44. The ROM 42 contains software programs executable by the processor 24 to enable the computer system components to perform tasks such as acting as a network attached storage device, and to assist in automated publishing of user content to web pages.

The home network server 20 further comprises a drive controller 46 coupled to the south bridge 34 by way of the illustrative PCI bus 38. In alternative embodiments, the drive controller may couple to the primary expansion bus 36, or any other currently available or after-developed expansion bus. The drive controller 46 controls the non-volatile memory 48, such as a hard drive or optical drive. In some embodiments, the home network server 20 implements a single hard drive where computer systems of the home network can store and retrieve data and programs. In alternative embodiments, the home network server 20 implements a redundant array of independent (or inexpensive) devices (RAID) system where the data and instructions written to the home network server are duplicated across multiple hard drives to implement fault tolerance.

Also coupled to the illustrative PCI bus 38 is a network interface card (NIC) 50. In alternative embodiments, the functionality of the NIC 50 is integrated onto the motherboard along with the bridges 28 and 34. Regardless of the precise location where the NIC is implemented, the NIC 50 enables the home network storage 20 to communicate with other computer systems on the home networking system 100 (through the router 14 of FIG. 1) such that the home network server can assist in automation publishing of user content to web pages.

Because the home network server 20 is designed to act as a server for the home network system 100, and possibly to reduce cost, in accordance with at least some embodiments the home network server 20 does not support direct coupling of a display device and/or keyboard. Thus, in some embodiments a home network sever 20 does not implement a graphics controller that would couple to a display, and also does not implement an input/output (I/O) controller that would couple to I/O devices such as a keyboard and mouse. To the extent administration is performed on the home network server 20, the administration may be accomplished remotely using other computer systems (e.g., desktop computer system 10 or portable computer system 16) in the home network system 100.

In order to address user account information administration in the home network system 100, the user accounts existing on computer systems 10, 16 are automatically and transparently duplicated on the home network server 20. Moreover, in some embodiments the home network server 20 captures password changes in computer systems 10, 16, and updates the passwords for corresponding login names in the home network server 20 and other computer systems 10, 16 in the home networking system 100. In yet still other embodiments, the home network server 20 automatically manages user accounts such that any account created on any computer system 10, 16 is not only automatically created on the home network server 20, but also is (optionally) automatically created on each every computer system 10, 16 in the home network system 100. In this way, a user may perform a login on any computer system in the home network system 100 after having created account information on only one computer system. In accordance with at least some embodiments, the home network system 100 comprising the home network server 20 provides single point authentication for the entire home network. For example, a user performs a login on one of the computer systems 10, 16. If the login to the computer system 10, 16 is successful, software operating on the computer system (possibly installed during an installation procedure) automatically and transparently performs a login operation on the home network server 20, such as by a remote procedure call.

Further still, the home network server 20 enables access to the home network from computer systems external to the home network system 100, such as from an office computer (e.g., computer system 102) coupled to the home network system 100 over the Internet 12. In these embodiments, the user seeking remote access performs a login to the home network server 20 using the login name and password used when logging directly into the computer systems 10, 16. Once authenticated by the home network server 20, the home network server 20 enables the person seeking remote access to data on the home network server 20, and possibly also to the computer systems 10, 16.

In accordance with the various embodiments, the home network server 20 participates in automating the selection of content for web pages, and possibly also the creation and publication of web pages. Consider, as an example, that a user of computer system 10 couples a memory device to the computer system 10, the memory device storing content. While the description proceeds with respect to coupling a memory device to computer system 10, the description is equally applicable to portable computer system 16. Coupling the memory device may take many forms. In some embodiments, the memory device may be a flash memory device from a digital camera (e.g., still, video). In other embodiments, the user couples the digital camera itself to the computer system 10. Regardless of the precise form of the memory device, the operating system of the computer system recognizes the coupling the memory device and causes the memory area of the memory device to become accessible to the computer system 10.

Upon coupling of the memory device to the computer system 10, the computer system 10 executes a program that inspects the contents of the memory device (e.g., determines the various file types), and instantiates a new window which provides the user of set of possible functions to perform related to the content on the memory device. For example, in the case of the memory device storing digital pictures or digital video, the window may ask the user if the user wants to view the pictures and/or video using any one of a group of playback programs. In accordance with the various embodiments, one of the possible tasks selectable by the user is to publish some or all of the contents of the memory device to a web page.

If the user indicates a desire to publish content to a web page, the computer system 10 instantiates a program that displays the contents of the memory device. Displaying the contents may take many forms. In the case of the content being digital photographs, displaying the content involves displaying the digital photographs stored on the memory device either in full resolution and size, or possibly in “thumbnail” form with reduced resolution. In the case of the content being a text-type document, displaying the content involves displaying the document either in full resolution (e.g., with the program that created the document), or possibly in thumbnail form. In addition to displaying the contents, the program also enables the user to select some or all the content for incorporating into a web page. For example, each piece of content may have a check-box associated therewith, or when selected the content may be highlighted in some form.

However, in some embodiments the content selection and eventual creation of a web page and publishing of the web page is constrained by a set of rules. The set of rules define various characteristics of the selection, web page creation and publication processes. For example, the set of rules may: disallow particular logins (e.g., family teenager) from publishing photographs without specific approval; disallow selection of files of particular size (e.g., digital photographs that are too large); disallow deletion and/or overwriting of previously created and published web pages; disallow certain words within captions to photographs; disallow selection and/or incorporation of digital video (e.g., digital video clips that are too large); or disallow selection of particular types of files for incorporation of the web page. The list of rules is merely illustrative, and any rule regarding who may select content, the type of content selectable, and/or other inclusions in the web pages created may be implemented in the set of rules.

Creation of the set of rules likewise may take many forms. In some embodiments, when an administrator of the home network system 100 installs programs to enable the selection of content, creation of web pages and publication of web pages, the administrator may be prompted to provide answers to a series of questions (e.g., authorized users, authorized computer systems, passwords for future changes). In other embodiments, the first time the program is instantiated, the set of rules may be established.

A user may couple a memory device to any computer system 10, 16 within the home with the desire to create a web page and publish the web page. In order that the set of rules used for such selection, creation and publication are consistent independent of the computer system 10, 16 to which the memory device is coupled, and accordance with the various embodiments, the primary copy of the set of rules is stored on the non-volatile memory 48 (FIG. 2) of the home network server 20. When the computer system 10, 16 instantiates the program that enables selection of content, creation of web pages and publication of web pages, in some embodiments the set of rules is copied from the home network server 20 to the computer system 10, 16. In other embodiments, the computer systems 10, 16 store local copies of the set of rules, and periodically, or upon each instantiation, ensure that the local copy of the set of rules match the master copy in the home network server 20 (e.g., such as by comparing a hash of the set of rules, or by comparing the modified date of the file containing the set of rules).

Regardless the precise mechanism by which the content is displayed and selected, in accordance with the various embodiments a web page is created and/or modified to contain the contents selected by the user. In order to simplify the web page creation process, and in accordance with various embodiments, the web page creation and/or modification is completed using the selected content and without further interaction of the user. Stated otherwise, generating and/or modifying a web page utilizing the content selected by the user occurs autonomously of the user. For example, a program may be provided the selected content, and the program creates and/or modifies a web page (e.g., in hypertext markup language (HTML) or extensible HTML (XHTML)) to include the selected content. In this way the user, particularly a home user, need not be familiar with programming and coding languages used for encoding of web pages.

The program used to create and/or modify the web page comprising the selected content may execute in a variety of locations. In some embodiments, the program executes on the computer system 10, 16 to which the memory device is coupled. Having each and every computer system 10, 16 in the home network 100 support the programs to create and/or modify the web page autonomously of the user may dictate purchasing or licensing multiple copies of an underlying program used for the creation, such Dreamweaver available from Adobe Systems Incorporated of San Jose, Calif. In alternative embodiments, the home network server 20 is provided the selected content, and the home network server 20 runs programs that create and/or modify the web page. Regardless of the location where programs are run to create and/or modify the web page, the creation and/or modification is completed autonomously of the user.

Making a web page available for viewing by way of browser program is a multiple-step process, and creation of the HTML or XHTML document is merely part of the process. Another portion of the process is publication of the web page and related content to a location accessible by way of a browser program. Much like creation and/or modification of a web page, proper publication of a web page and its related content is a complicated process, comprising creation of directories within the file system of the computer system which hosts the web page, copying of various files into the directory (over and above the web page itself), and setting appropriate permissions for external devices to access the directory. Like web page creation and/or modification, most home users of computer systems do not have the skills or the inclination to learn the skills for proper publication. Thus, in accordance with the various embodiments, the process of publication of the web page and corresponding files is completed without further interaction of the user. Stated otherwise, creating directories, setting permissions and copying of various files as part of the publication process is completed autonomously of the user. In this way the user, particularly a home user, need not be familiar with the various technical requirements for proper publication of a web page and related content. Here again, the one or more programs that perform the publication process may execute in a variety of locations. In some embodiments, the one or more programs execute on the computer system 10, 16 to which the memory device was connected. In yet still other embodiments, the one or more programs execute at a central location, such as the home network server 20.

Another factor to consider in the autonomous creation and/or modification and publication of web pages is the location to which the publication takes place. While publication may be to any computer system coupled externally to (such as servers available across the Internet 12) or coupled within the home network system 100, in accordance with some embodiments the web pages and related content are published to the home network server 20 (or another home network server within the home). In this way, computer systems 10, 16 within home network system 10 (that is, computer systems co-located within the home) may access and view the web pages using browser programs, even if the home network system 100 is not coupled to the Internet 12. Thus, in addition to being a central repository for information in the home network system 100 in a general sense, the home network server 20 hosts web pages of content generated using the methods and systems described above. Using the home network server 20 as the hosting mechanism eliminates the need for the home user to rent space on distance servers for hosting web pages.

The various embodiments described to this point assume both that the user couples the memory device to a computer system 10, 16 co-located with the home network server 20, and that attempts to view web pages created are also by way of co-located computer system 10, 16; however, the computer system used to select content and initiate autonomous web page creation and publication need not be within the home. For example, in some embodiments (and depending on permissions), a computer system 102 outside the home, yet coupled to the home network server 20, may be the computer system to which a user couples a memory device with the desire to create web pages and publish some or all of the content on the memory device. For example, a family on vacation may use a portable computer to reach the home network server 20 through an Internet connection, and from that portable computer select, create and publish pictures of the vacation.

When displaying, selecting, creating the web page and publishing from a computer system within the home (e.g., computer system 10), displaying content stored on other devices within the home (e.g., portable computer 16 or home network server 20) is relatively easy as the bandwidth available between those devices is relatively high (e.g., 100 Megabits per second (MB/S) Ethernet for hardwired connections, and approximately the same for some wireless connections like IEEE 802.11(g)). Thus, in some embodiments not only does the program display content from the memory device for possible selection, but the program may also display content from other storage locations within the home network system 100 as well. In this situation copying the content from the other storage locations is not particularly bandwidth limited. However, when accessing the home network system 100 from an external connection across Internet 12, the available bandwidth may be significantly less (e.g., on the order of 1 to 3 MB/S for “high” bandwidth connections). In order for the non-local computer system 102 to display content for possible selection, where that content is stored within the home network system 100, the home network server 20 stores reduced resolution versions (e.g., thumbnails) of the content. When the remote computer system 102 starts the process of selecting content, the reduced resolution versions of the content are transferred across the Internet 12 to the remote computer 102 so that at least some of the content within the home network system 100 is also available for selection and incorporation into the web page.

FIG. 3 illustrates a method in accordance with various embodiments. In particular, the method starts (block 300) and proceeds to a user coupling a memory device to a computer system (block 304). The memory device may be, for example, a flash memory device or the memory device may be a digit still or video camera on which pictures and video are stored. The computer system to which the memory device is coupled receives a set of rules for content selection (block 308). In some embodiments, the set of rules is copied from a central location, such as a co-located home network server. In other embodiments, the set of rules is copied prior to coupling of the memory device, and the set of rules may or may not be checked for completeness upon the coupling of the memory device. The content of the memory device is displayed for the user (block 312).

The user selects at least some of the content (block 316), the selecting consistent with the set of rules. In some embodiments, the content available for selection is not only the content from the memory device, but also content stored on the computer system or possibly content stored on the home network server. Selecting the content may involve checking “check boxes” displayed proximate to the content, or the selected content may be highlight in some other fashion. Once the content selection is complete, a web page is generated and/or modified utilizing the content selected by the user, and the generating is completed autonomously of the user (block 320). Generating the web page content autonomously of the user frees the user from needing to know or learn the various coding languages used for web page creation and viewing. Further, the generating may be by way of programs on the computer system to which the memory device is attached, or the generating may be at a central location, such as the home network server.

After generating the web page, the web page and its contents are published in such a way as to be available for viewing by a web browser (block 324), the publication completed autonomously of the user. Publishing the content autonomously of the user frees the user from needing to know or learn the various technical aspects of publishing a web page for viewing. The publishing may be to any available computer systems, but in some embodiments the publishing is to a home network server. Thereafter, the process ends (block 328). Publishing to a home network server enables the user to view pages of selected content from within home, without the need of renting server space at a server available over the Internet, and further without the Internet connection for the home being provided or operational.

From the description provided herein, those skilled in the art are readily able to combine software created as described with appropriate general-purpose or special-purpose computer hardware to create a computer system and/or computer subcomponents in accordance with the various embodiments, to create a computer system and/or computer subcomponents for carrying out the methods of the various embodiments, and/or to create a computer-readable media for storing a software program to implement the method aspects of the various embodiments.

The above discussion is meant to be illustrative of the principles and various embodiments of the present invention. Numerous variations and modifications will become apparent to those skilled in the art once the above disclosure is fully appreciated. For example, coupling of a memory device to the computer system 10, 16 is discussed as the mechanism to trigger instantiation of the program to enable display, selection, creation and publication of content; however, the program may be instantiated manually by the user and may operate on content of memory device previously coupled to the computer system, or on content previously saved to the computer system 10, 16 (e.g., pictures on the computer system 10, 16 having been cropped or after red eye removal). It is intended that the following claims be interpreted to embrace all such variations and modifications.

What is claimed is:

1. A method comprising:
coupling a memory device to a computer system;
displaying content of the memory device on the computer system;
selecting by the user at least some of the content displayed;
generating a web page utilizing the content selected by the user, the generating occurring autonomously of the user; and
publishing the web page to a server, the publishing occurring autonomously of the user.

2. The method as defined in claim 1 wherein coupling the memory device further comprises at least one selected from the group consisting of: coupling a digital video camera to the computer system; coupling a digital still camera to the computer system; and coupling a flash memory device to the computer system.

3. The method as defined in claim 1 wherein displaying the content further comprises at least one selected from the group consisting of: displaying pictures stored on the memory device; displaying low resolution versions of pictures stored on the memory device; displaying documents stored on the memory device; and displaying reduced resolution versions of pictures stored on the memory device.

4. The method as defined in claim 1 wherein selecting further comprises:
receiving by the computer system a set of rules for selection of content; and
enabling the user to select content consistent with the rules.

5. The method as defined in claim 4 wherein receiving further comprises at least one selected from the group consisting of: receiving from a home network attached storage device co-located in a home with the computer system; and receiving from a home network attached storage device.

6. The method as defined in claim 1 wherein generating the Web page further comprises generating autonomously of the user a Web page in hypertext markup language (HTML) that utilizes content selected by the user.

7. The method as defined in claim 1 wherein publishing further comprises one or more selected from the group consisting of: publishing to a home network attached storage device co-located in the home with the computer system; and publishing to a home network attached storage device.

8. A network server comprising:
a processor;
a memory coupled to the processor;
a set of rules for selecting of content of a Web page, the set of rules stored in the memory;
wherein the network server forwards the set of rules to a computer system coupled to the network server when the computer system is used to select content for automated creation of the Web page based on selected content.

9. The network server as defined in claim 8 wherein the network server forwards the set of rules to the computer system locally coupled to the network server.

10. The network server as defined in claim 8 wherein the network server hosts the web page.

11. The network server as defined in claim 8 wherein the network server generates the web page using content selected by a user and forwarded to the network server by the computer system.

12. The network server as defined in claim 8 wherein the memory further comprises at least one selected from the group consisting of: random access memory; and a hard drive.

13. A computer-readable medium storing a program that, when executed by a processor, cause the processor to:
detect coupling of a memory device to the processor;
copy a set of rules from a remotely located computer system;
display content of the memory device on a display device coupled to the processor; and
enable a user to select content of the memory device for publication to a web page, the selection in conformance with the set of rules.

14. The computer-readable medium as defined in claim 13 wherein program further causes the processor to:
generate the web page utilizing the content selected by the user, the generating occurring autonomously of the user; and
publishing the web page to a server, the publishing occurring autonomously of the user.

15. The computer-readable medium as defined in claim 13 wherein the program further causes the processor to send the selected content to a server, wherein the server generates the web page and publishes the web page.

16. The computer-readable medium as defined in claim 13 wherein the program further causes the processor to send the selected content to a network attached storage device.

17. A computer-readable medium storing a program that, when executed by a processor, causes the processor to:
send a set of rules regarding selection of web page content to a computer system coupled to the processor; and
host on a memory device locally coupled to the processor a web page having content selected in conformance with the set of rules.

18. The computer-readable medium as defined in claim 17 wherein the program further causes the processor to:
receive content from the computer system coupled to the processor;
generate the web page based on the content received; and
publish the content to the memory device for browser-based viewing of the web page.

19. The computer-readable medium as defined in claim 18 wherein when the processor receives the content, the program causes the processor to receive the content from the computer system.

20. The computer-readable medium as defined in claim 21 wherein the program further causes the processor to selectively enable/deny, based on the set of rules, the user access to previously selected content.

21. A computer-readable medium storing a program that, when executed by a processor, causes the processor to:
send a set of rules regarding selection of web page content to a first computer system coupled to the processor; and
generate a web page having content selected in conformance with the set of rules; and
publish the web page to a second computer system.

22. The computer-readable medium as defined in claim 21 wherein the program further causes the processor to receive the content from the computer system.

23. The computer-readable medium as defined in claim 21 wherein the program further causes the processor to selectively enable/deny, based on the set of rules, the user access to previously selected content.
